(19) United States
(12) Patent Application Publication
(10) Pub. No.: US 2025/0356186 A1
(43) Pub. Date: Nov. 20, 2025

(54) TECHNIQUES FOR UNIFIED PHYSICS-BASED CHARACTER CONTROL THROUGH MASKED MOTION INPAINTING

(71) Applicant: NVIDIA CORPORATION, Santa Clara, CA (US)

(72) Inventors: Chen TESSLER, Zichron Yaakov (IL); Gal CHECHIK, Tel Aviv (IL); Ofir NABATI, Tel Aviv (IL); Jason PENG, Vancouver (CA)

(21) Appl. No.: 18/983,145

(22) Filed: Dec. 16, 2024

Related U.S. Application Data
(60) Provisional application No. 63/647,304, filed on May 14, 2024.

(51) Int. Cl. G06N 3/08; G06T 13/40

(52) U.S. Cl. CPC G06N 3/08; G06T 13/40

(57) ABSTRACT

One embodiment of a method for animating characters includes receiving one or more goals specified in one or more modalities, generating, via a trained machine learning model and based on the one or more goals, a first action for a character to perform, where the trained machine learning model is trained to process inputs in multiple modalities, and causing the character to perform the first action within a computer-based or physical environment.

### CROSS-REFERENCE TO RELATED APPLICATIONS

This application claims priority of the United States Provisional Patent Application titled, “UNIFIED PHYSICS-BASED CHARACTER CONTROL THROUGH MASKED MOTION INPAINTING,” filed on May 14, 2024, and having Ser. No. 63/647,304. The subject matter of this related application is hereby incorporated herein by reference.

### BACKGROUND

### Technical Field

Embodiments of the present disclosure relate generally to robotics, virtual character control, and artificial intelligence and machine learning and, more specifically, to techniques for unified physics-based character control through masked motion inpainting.

### Description of the Related Art

Character animation is the process of creating a series of different poses, expressions, and/or actions of a character that can be played back sequentially. Character animations can be created in various ways, including drawing animations by hand, via stop-motion, and via computer-generation.

One approach for creating computer-generated character animations is through a manual process in which animators use software to design and move three-dimensional (3D) virtual models of characters in ways the characters may move in given animation sequences. For example, an animator could use software to specify the positions and orientations of the joints associated with the head, torso, arms, etc. of a character within a number of key frames of a given animation. To create a full animation, the software can use kinematic modeling to compute the positions and orientations of the same joints within frames that reside in between the key frames. The character can then be animated to move in a manner that tracks the positions and orientations of the joints within the key frames and the in-between frames.

One drawback of the above approach for creating computer-generated character animations is that, as a general matter, the animator is required to specify the positions and orientations of all of the joints of the character within the key frames to create the animation of that character. Few, if any, conventional software programs exist that can automatically determine physically plausible positions and orientations for joints of a character that have not been specified by an animator in any key frames. In addition, the kinematic modeling used to compute the positions and orientations of joints within in-between frames does not consider the forces that cause those joints to move, which can include motor forces that move the joints and also collisions/contacts that alter the directions of motion. Instead, the kinematic modeling computes only the motion of joints required to move between the positions and orientations of joints within key frames. Because forces are not considered, the resulting animations are oftentimes not physically realistic, which negatively impacts overall visual quality.

Another approach for creating computer-generated character animations is to train a machine learning model, such as an artificial neural network, to output the positions and orientations of joints of a character across multiple different frames to generate an animation sequence. In these types of implementations, a machine learning model is typically trained, either from scratch or by re-training a reusable previously-trained machine learning model, to output the joint positions and orientations for a specific motions, such as walking or sitting. One drawback of this approach, though, is that a machine learning model that is trained for a specific task, such as walking or sitting, cannot be used to generate animations where a character performs a different motion, such as running or climbing stairs. In some instances, a machine learning model can be trained to receive a latent vector of numbers as input and output different character joint positions and orientations that are not limited to any specific motion. However, the numbers in a latent vector are not easily interpretable by animators, who can have difficulty selecting the specific values corresponding to a particular desired motion of a character. Accordingly, these types of machine learning models cannot be effectively controlled by animators and, consequently, have limited utility in generating animations.

As the foregoing illustrates, what is needed in the art are more effective techniques for generating computer-based character animations that are physically plausible.

### SUMMARY

One embodiment of the present disclosure sets forth a computer-implemented method for animating characters. The method includes receiving one or more goals specified in one or more modalities. The method further includes generating, via a trained machine learning model and based on the one or more goals, a first action for a character to perform, where the trained machine learning model is trained to process inputs in multiple modalities. In addition, the method includes causing the character to perform the first action within a computer-based or physical environment.

Another embodiment of the present disclosure sets forth a computer-implemented method for training machine learning models to animate characters. The method includes performing, using a set of motion recordings, one or more first operations to train a first untrained machine learning model to generate a first trained machine learning model that is configured to animate a character based on motion data as input. The method further includes performing, using the set of motion recordings and the first trained machine learning model, one or more second operations to train a second untrained machine learning model to generate a second trained machine learning model that is configured to animate the character based on user input.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that, with the disclosed techniques, a physical or virtual character can be animated to perform different motions without specifying all of the joints of the character in any number of frames of an animation. Animations generated using the disclosed techniques are also more physically plausible relative to what can be achieved by animations generated using kinematic models that do not consider the forces that cause the joints of a character to move. In addition, the disclosed techniques permit animators to effectively control animations by specifying joint constraints, text descriptions, and/or objects that characters interact with. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer-based system configured to implement one or more aspects of the various embodiments;

FIG. 2 is a more detailed illustration of the machine learning server of FIG. 1, according to various embodiments;

FIG. 3 is a more detailed illustration of the computing device of FIG. 1, according to various embodiments;

FIG. 4 is a more detailed illustration of the model trainer of FIG. 1, according to various embodiments;

FIG. 5 is a more detailed illustration of the reinforcement learning module of FIG. 4, according to various embodiments;

FIG. 6 is a more detailed illustration of the supervised imitation learning module of FIG. 4, according to various embodiments;

FIG. 7 is a more detailed illustration of the partially-constrained controller of FIG. 4, according to various embodiments;

FIGS. 8A-8C illustrate exemplar simulated terrains that can be used during training of fully-constrained and partially-constrained controllers, according to various embodiments;

FIG. 9 is a more detailed illustration of the control application of FIG. 1, according to various embodiments;

FIG. 10 is a more detailed illustration of how the partially-constrained controller of FIG. 1 is used to control a character, according to various embodiments;

FIGS. 11A-11C illustrates exemplar motions generated by controlling a character using different modalities, according to various embodiments.

FIG. 12 sets forth a flow diagram of method steps for training a fully-constrained controller and using the trained fully-constrained controller to train a partially-constrained controller, according to various embodiments;

FIG. 13 sets forth a flow diagram of method steps for training a partially-constrained controller, according to various embodiments; and

FIG. 14 sets forth a flow diagram of method steps for generating an animation of a character given a sparse goal, according to various embodiments.

### DETAILED DESCRIPTION

In the following description, numerous specific details are set forth to provide a more thorough understanding of the various embodiments. However, it will be apparent to one skilled in the art that the concepts can be practiced without one or more of these specific details.

### General Overview

Embodiments of the present disclosure provide techniques for animating characters using sparse goals. In some embodiments, a sparse goal can be specified in various modalities, such as joint constraints, a text description, and/or an object that a character interacts with. A control application processes the goal input in each modality using a corresponding modality-specific encoder to generate tokens. Given the tokens, token masks indicating which tokens are associated with unspecified inputs, and a current state of the character, the control application samples a prior latent distribution generated by a prior of a trained partially-constrained controller to obtain a sampled latent vector. The character can be a virtual character in a computer-based environment or a physical robot in a real-world environment, and the current state of the character can be received from the computer-based environment or sensed using sensors in the real-world environment. The control application inputs the sampled latent vector and the current state of the character into a decoder of the partially-constrained controller to generate an action. Thereafter, the control application can control the character within the computer-based environment or the real-world environment using the action. Control of the character can result in an updated state of the character, and the foregoing process can be repeated to generate another action for controlling the character using the updated state of the character, the sparse goal, and the partially-constrained controller.

A model trainer can perform a two-stage training technique to train the partially-constrained controller. In the two-stage technique, the model trainer (1) trains a fully-constrained controller using reinforcement learning to predict sequences of actions that reconstruct reference motions in simulation, and then (2) trains the partially-constrained controller using supervised imitation learning to recover the same actions as the trained fully-constrained controller for masked goals in simulation. The reinforcement learning can include, for each of a number of iterations, computing a reward based on a difference between a state of a character after performing an action output by the fully-constrained controller and a ground-truth state of the character in the reference motions, and updating parameters of the fully-constrained controller based on the reward. In some embodiments, the reward can also include one or more regularization terms on the motion, such as regularization term(s) for reducing energy consumption, impact minimization, and/or minimal motorjitter terms. The supervised imitation learning can include repeatedly sampling a motion from the reference motions and a timestep within the motion, sampling a mask for a goal associated with the sampled motion, simulating an action that is computed by the partially-constrained controller for achieving the masked goal, computing a ground-truth action using the fully-constrained controller, computing a similarity loss (e.g., an L2 or Kullback-Leibler (KL) divergence loss) based on a comparison between the action and the ground-truth action, and updating parameters of the partially-constrained controller based on the similarity loss. More generally, the second stage of training can include a combination of matching a ground truth action and/or maximizing a reward.

The techniques for animating characters have many real-world applications. For example, those techniques could be used to animate a character in a virtual or extended reality (XR) environment, such as a gaming environment. As another example, those techniques could be used to control a physical robot in a real-world environment.

The above examples are not in any way intended to be limiting. As persons skilled in the art will appreciate, as a general matter, the techniques for animating characters described herein can be implemented in any suitable application.

### System Overview

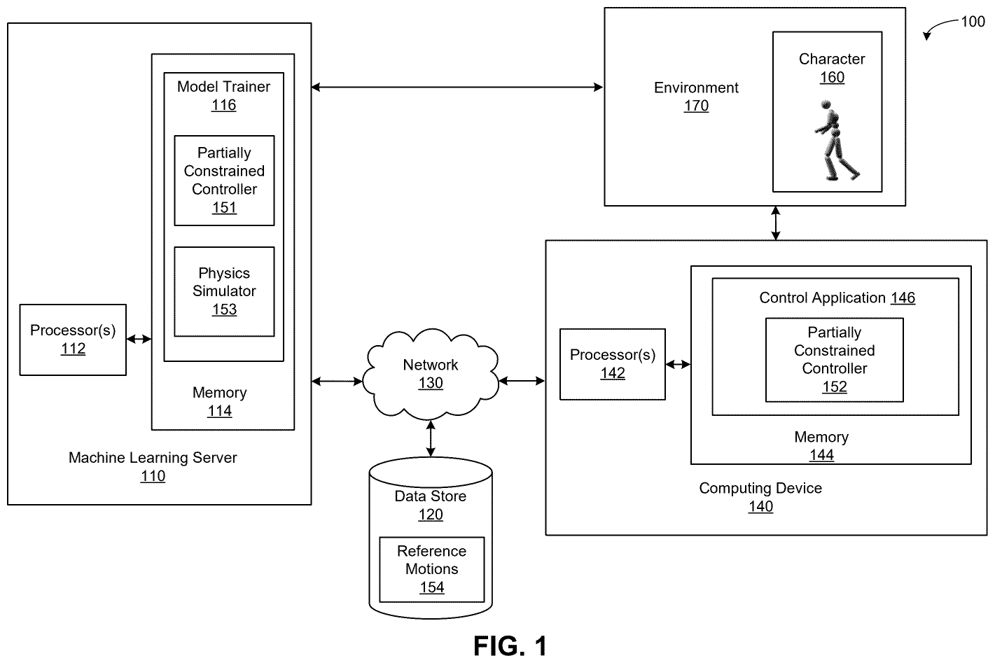

FIG. 1 illustrates a block diagram of a computer-based system 100 configured to implement one or more aspects of various embodiments. As shown, the system 100 includes a machine learning server 110, a data store 120, and a computing system 140 in communication over a network 130, which can be a wide area network (WAN) such as the Internet, a local area network (LAN), a cellular network, and/or any other suitable network.

As shown, a model trainer 116 executes on one or more processors 112 of the machine learning server 110 and is stored in a system memory 114 of the machine learning server 110. The processor(s) 112 receive user input from input devices, such as a keyboard or a mouse. In operation, the processor(s) 112 may include one or more primary processors of the machine learning server 110, controlling and coordinating operations of other system components. In particular, the processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the machine learning server 110 stores content, such as software applications and data, for use by the processor(s) 112 and the GPU(s) and/or other processing units. The system memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to the processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

The machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In some embodiments, any combination of the processor(s) 112, the system memory 114, and/or GPU(s) can be included in and/or replaced with any type of virtual computing system, distributed computing system, and/or cloud computing environment, such as a public, private, or a hybrid cloud system.

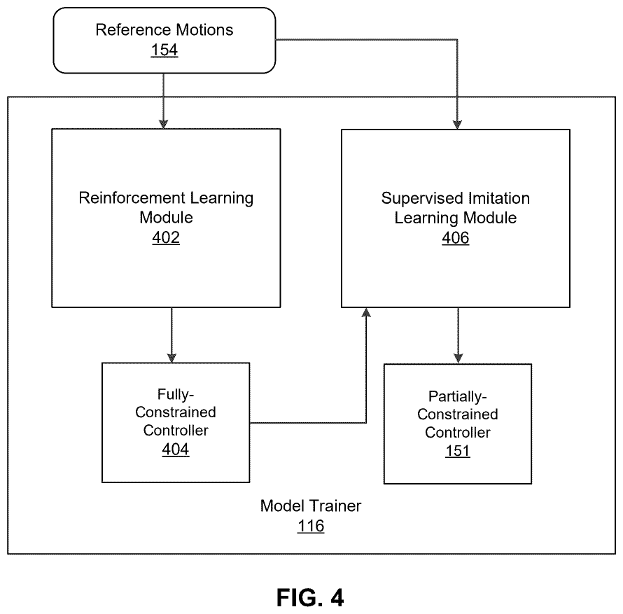

In some embodiments, the model trainer 116 is configured to train one or more machine learning models, including a partially constrained controller 151 that is trained to generate actions for animating a character given a sparse goal that can be specified in one or more modalities, such as joint constraints, a text description, and/or an object the character is to interact with. Techniques that the model trainer 116 can employ to train the partially constrained controller 151 are discussed in greater detail below in conjunction with FIGS. 4-8 and 12-13. Training data and/or trained (or deployed) machine learning models, including the partially constrained controller 151, can be stored in the data store 120. In some embodiments, the data store 120 can include any storage device or devices, such as fixed disc drive(s), flash drive(s), optical storage, network attached storage (NAS), and/or a storage area-network (SAN). Although shown as accessible over the network 130, in at least one embodiment the machine learning server 110 can include the data store 120.

Illustratively, the data store 120 also stores reference motions 154. The reference motions 154 are used for training the partially-constrained controller 151. In some embodiments, the reference motions 154 include recorded motions of humans that are used to evaluate the generated motions of the partially-constrained controller 151. In various examples, the reference motions 154 are curated from various human activities that are, for example, collected through motion capture technologies.

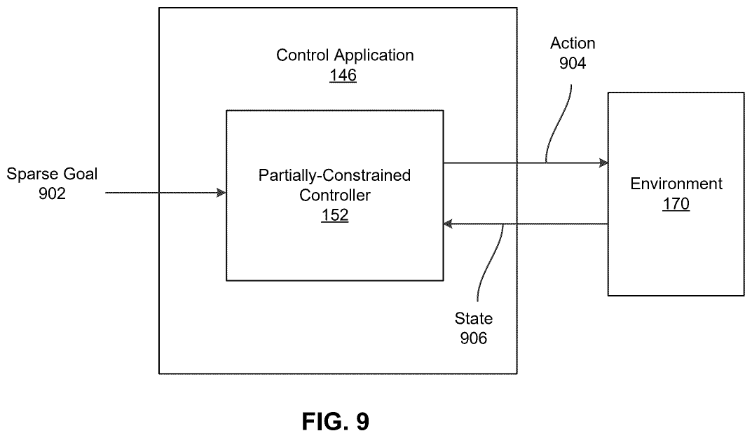

As shown, a control application 146 that uses a trained partially-constrained controller 152 is stored in memory 144, and executes on processor(s) 142, of the computer device 140. The control application 146 is discussed in greater detail below in conjunction with FIGS. 9-10 and 14. Illustratively, the control application 146 uses the partially-constrained controller 152, which in some embodiments can be the train partially constrained controller 151 without an encoder, to control a character 160 to move within an environment 170.

The environment 170, in which the character 160 performs actions, can be either a computer-based environment or a physical environment. A computer-based environment can be simulated in any technically feasible manner in some embodiments, such as using a 3D engine, a generative model (e.g., a neural network) that predicts the next state given an action, etc. For example, in a computer-based 3D virtual environment, the character 160 could navigate a digital landscape, such as a simulation of a cityscape with moving traffic and pedestrians, a fantasy world with dynamic terrain and interactive elements, and/or the like. Computer-based environments can be used in video game development, virtual reality (VR) applications, advanced artificial intelligence (AI) training simulations, and/or the like. In a physical environment, the character 160, such as a humanoid robot, can navigate real-world scenarios, such as a robot moving through a warehouse to perform logistics operations, maneuvering in a hospital to deliver supplies, operating in hazardous environments such as nuclear facilities where human presence is risky, and/or the like.

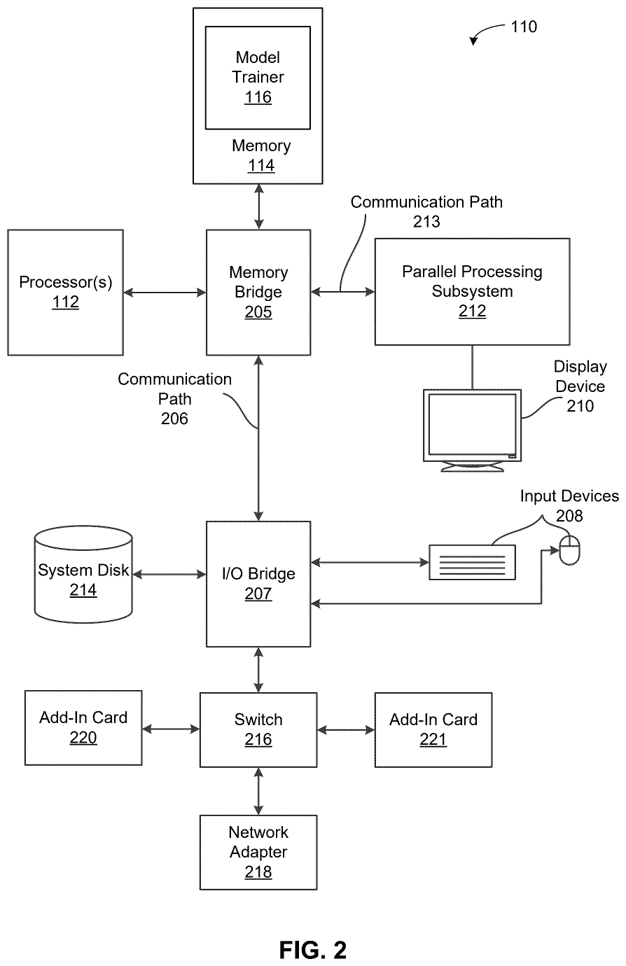

FIG. 2 is a more detailed illustration of the machine learning server 110 of FIG. 1, according to various embodiments. In some embodiments, the machine learning server 110 can include any type of computing system, including, without limitation, a server machine, a server platform, a desktop machine, a laptop machine, a hand-held/mobile device, a digital kiosk, an in-vehicle infotainment system, and/or a wearable device. In some embodiments, the machine learning server 110 is a server machine operating in a data center or a cloud computing environment that provides scalable computing resources as a service over a network.

In some embodiments, the machine learning server 110 includes, without limitation, the processor(s) 112 and the memory(ies) 114 coupled to a parallel processing subsystem 212 via a memory bridge 205 and a communication path 206. Memory bridge 205 is further coupled to an I/O (input/output) bridge 207 via a communication path 206, and 1/O bridge 207 is, in turn, coupled to a switch 216.

In some embodiments, the I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In some embodiments, the machine learning server 110 can be a server machine in a cloud computing environment. In such embodiments, the machine learning server 110 can not include input devices 208, but can receive equivalent input information by receiving commands (e.g., responsive to one or more inputs from a remote computing device) in the form of messages transmitted over a network and received via a network adapter 218. In some embodiments, the switch 216 is configured to provide connections between I/O bridge 207 and other components of the machine learning server 110, such as a network adapter 218 and various add in cards 220 and 221.

In some embodiments, the I/O bridge 207 is coupled to a system disk 214 that may be configured to store content and applications and data for use by the processor(s) 112 and the parallel processing subsystem 212. In some embodiments, the system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In some embodiments, other components, such as universal serial bus or other port connections, compact disc drives, digital versatile disc drives, film recording devices, and the like, may be connected to the I/O bridge 207 as well.

In some embodiments, the memory bridge 205 may be a Northbridge chip, and the I/O bridge 207 may be a Southbridge chip. In addition, the communication paths 206 and 213, as well as other communication paths within the machine learning server 110, can be implemented using any technically suitable protocols, including, without limitation, AGP (Accelerated Graphics Port), HyperTransport, or any other bus or point to point communication protocol known in the art.

In some embodiments, the parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212.

In some embodiments, the parallel processing subsystem 212 incorporates circuitry optimized (e.g., that undergoes optimization) for general purpose and/or compute processing. Again, such circuitry may be incorporated across one or more PPUs included within the parallel processing subsystem 212 that are configured to perform such general purpose and/or compute operations. In yet other embodiments, the one or more PPUs included within the parallel processing subsystem 212 may be configured to perform graphics processing, general purpose processing, and/or compute processing operations. The system memory 114 includes at least one device driver configured to manage the processing operations of the one or more PPUs within the parallel processing subsystem 212. In addition, the system memory 114 includes the model trainer 116, discussed in greater detail below in conjunction with FIGS. 4-5 and 9. Although described herein primarily with respect to the model trainer 116, techniques disclosed herein can also be implemented, either entirely or in part, in other software and/or hardware, such as in the parallel processing subsystem 212.

In some embodiments, the parallel processing subsystem 212 can be integrated with one or more of the other elements of FIG. 2 to form a single system. For example, the parallel processing subsystem 212 can be integrated with the processor(s) 112 and other connection circuitry on a single chip to form a system on a chip (SoC).

In some embodiments, the processor(s) 112 includes the primary processor of the machine learning server 110, controlling and coordinating operations of other system components. In some embodiments, the processor(s) 112 issues commands that control the operation of PPUs. In some embodiments, the communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 112, and the number of parallel processing subsystems 212, can be modified as desired. For example, in some embodiments, the system memory 114 could be connected to the processor(s) 112 directly rather than through the memory bridge 205, and other devices can communicate with the system memory 114 via the memory bridge 205 and the processor(s) 112. In other embodiments, the parallel processing subsystem 212 can be connected to the I/O bridge 207 or directly to the processor(s) 112, rather than to the memory bridge 205. In still other embodiments, the I/O bridge 207 and the memory bridge 205 can be integrated into a single chip instead of existing as one or more discrete devices. In certain embodiments, one or more components shown in FIG. 2 may not be present. For example, the switch 216 could be eliminated, and the network adapter 218 and add in cards 220, 221 would connect directly to the I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in some embodiments. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

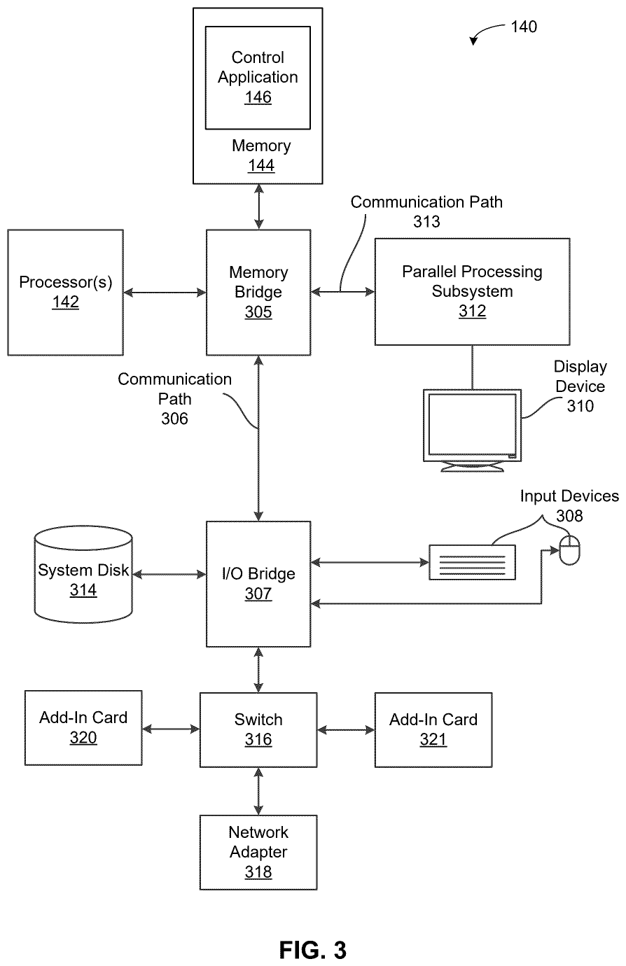

FIG. 3 is a more detailed illustration of the computing system 140 of FIG. 1, according to various embodiments. In some embodiments, the computing system 140 can include any type of computing system, including, without limitation, a server machine, a server platform, a desktop machine, a laptop machine, a hand-held/mobile device, a digital kiosk, an in-vehicle infotainment system, and/or a wearable device. In some embodiments, the computing system 140 is a server machine operating in a data center or a cloud computing environment that provides scalable computing resources as a service over a network.

In some embodiments, the computing system 140 includes, without limitation, the processor(s) 142 and the memory(ies) 144 coupled to a parallel processing subsystem 312 via a memory bridge 305 and a communication path 306. Memory bridge 305 is further coupled to an I/O (input/output) bridge 307 via a communication path 306, and I/O bridge 307 is, in turn, coupled to a switch 316.

In some embodiments, the I/O bridge 307 is configured to receive user input information from optional input devices 308, such as a keyboard, mouse, touch screen, sensor data analysis (e.g., evaluating gestures, speech, or other information about one or more uses in a field of view or sensory field of one or more sensors), and/or the like, and forward the input information to the processor(s) 142 for processing. In some embodiments, the computing system 140 can be a server machine in a cloud computing environment. In such embodiments, the computing system 140 can not include the input devices 308, but can receive equivalent input information by receiving commands (e.g., responsive to one or more inputs from a remote computing device) in the form of messages transmitted over a network and received via a network adapter 318. In some embodiments, the switch 316 is configured to provide connections between I/O bridge 307 and other components of the computing system 140, such as a network adapter 318 and various add in cards 320 and 321.

In some embodiments, the I/O bridge 307 is coupled to a system disk 314 that may be configured to store content and applications and data for use by the processor(s) 312 and the parallel processing subsystem 312. In some embodiments, the system disk 314 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In some embodiments, other components, such as universal serial bus or other port connections, compact disc drives, digital versatile disc drives, film recording devices, and the like, may be connected to the I/O bridge 307 as well.

In some embodiments, the memory bridge 305 may be a Northbridge chip, and the I/O bridge 307 may be a Southbridge chip. In addition, the communication paths 306 and 313, as well as other communication paths within the computing system 140, can be implemented using any technically suitable protocols, including, without limitation, AGP (Accelerated Graphics Port), HyperTransport, or any other bus or point to point communication protocol known in the art.

In some embodiments, the parallel processing subsystem 312 comprises a graphics subsystem that delivers pixels to an optional display device 310 that may be any conventional cathode ray tube, liquid crystal display, light-emitting diode display, and/or the like. In such embodiments, the parallel processing subsystem 312 may incorporate circuitry optimized for graphics and video processing, including, for example, video output circuitry. Such circuitry may be incorporated across one or more parallel processing units (PPUs), also referred to herein as parallel processors, included within the parallel processing subsystem 312.

In some embodiments, the parallel processing subsystem 312 incorporates circuitry optimized (e.g., that undergoes optimization) for general purpose and/or compute processing. Again, such circuitry may be incorporated across one or more PPUs included within the parallel processing subsystem 312 that are configured to perform such general purpose and/or compute operations. In yet other embodiments, the one or more PPUs included within the parallel processing subsystem 312 may be configured to perform graphics processing, general purpose processing, and/or compute processing operations. The system memory 144 includes at least one device driver configured to manage the processing operations of the one or more PPUs within the parallel processing subsystem 312. In addition, the system memory 144 includes the control application 146, discussed in greater detail in conjunction with FIGS. 9-10 and 14. Although described herein primarily with respect to the control application 146, techniques disclosed herein can also be implemented, either entirely or in part, in other software and/or hardware, such as in the parallel processing subsystem 312.

In some embodiments, the parallel processing subsystem 312 can be integrated with one or more of the other elements of FIG. 3 to form a single system. For example, the parallel processing subsystem 312 can be integrated with the processor(s) 142 and other connection circuitry on a single chip to form a system on a chip (SoC).

In some embodiments, the processor(s) 142 includes the primary processor of the computing system 140, controlling and coordinating operations of other system components. In some embodiments, the processor(s) 142 issues commands that control the operation of PPUs. In some embodiments, the communication path 313 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 312, and the number of parallel processing subsystems 312, can be modified as desired. For example, in some embodiments, the system memory 144 could be connected to the processor(s) 142 directly rather than through the memory bridge 305, and other devices can communicate with system memory 144 via the memory bridge 305 and the processor(s) 142. In other embodiments, the parallel processing subsystem 312 can be connected to the I/O bridge 307 or directly to the processor(s) 142, rather than to the memory bridge 305. In still other embodiments, I/O bridge 307 and the memory bridge 305 can be integrated into a single chip instead of existing as one or more discrete devices. In certain embodiments, one or more components shown in FIG. 3 may not be present. For example, the switch 316 could be eliminated, and the network adapter 318 and add the in cards 320, 321 would connect directly to the I/O bridge 307. Lastly, in certain embodiments, one or more components shown in FIG. 3 may be implemented as virtualized resources in a virtual computing environment, such as a cloud computing environment. In particular, the parallel processing subsystem 312 may be implemented as a virtualized parallel processing subsystem in some embodiments. For example, the parallel processing subsystem 312 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Unified Physics-Based Character Control Through Masked Motion Inpainting

FIG. 4 is a more detailed illustration of the model trainer 116 of FIG. 1, according to various embodiments. As shown, the model trainer 116 includes a reinforcement learning module 402 and a supervised imitation learning module 406. In operation, the model trainer 116 receives reference motions 154 for use in training the fully-constrained controller 404 and the partially-constrained controller 151. In some embodiments, the reference motions 154 can be a motion capture dataset that includes captured motions of humans performing various motions. In such cases, the reference motions 154 can include the positions and rotations for each of a number of joints in each frame of the captured motions.

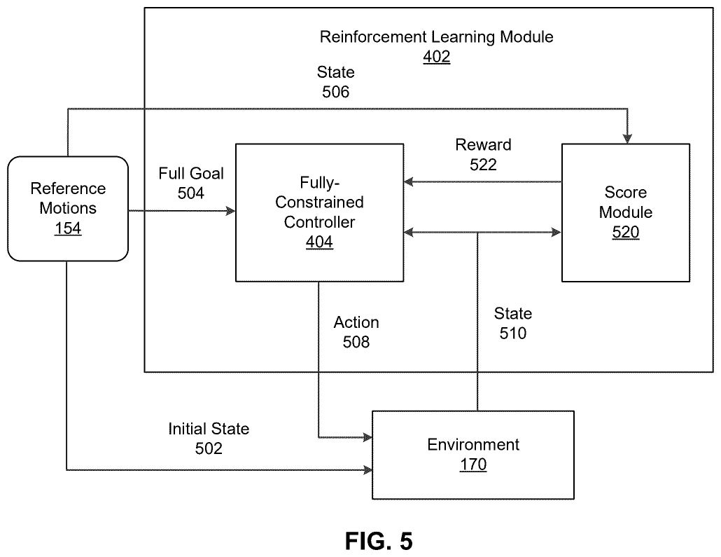

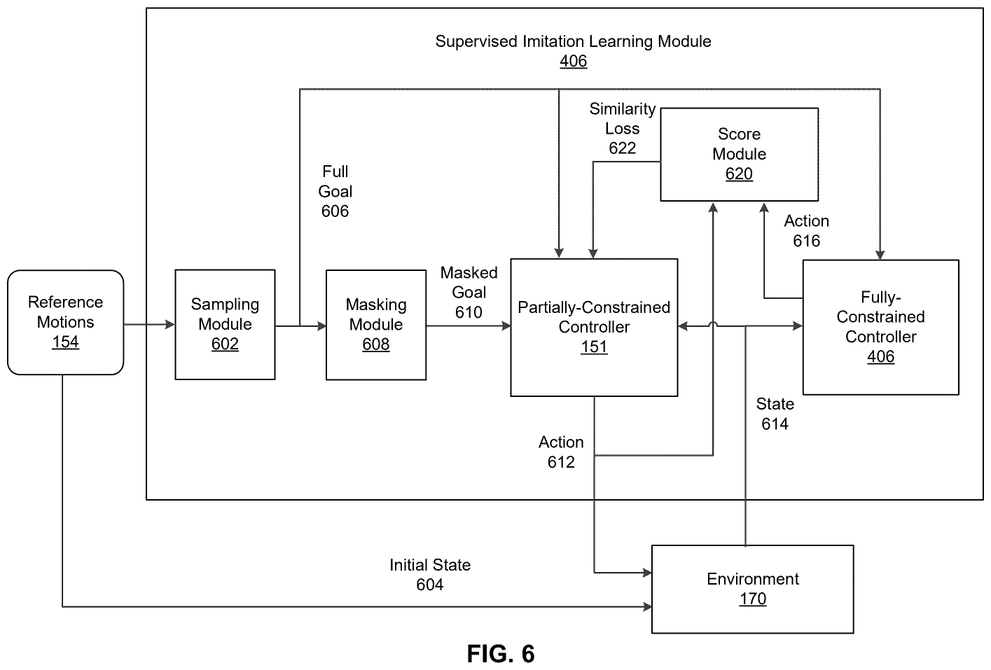

The model trainer 116 performs a two-stage training technique in which (1) the reinforcement learning module 402 first trains the fully-constrained controller 404 using reinforcement learning to predict sequences of actions that reconstruct the reference motions 154 in simulation, and then (2) the supervised imitation learning module 406 trains the partially-constrained controller 151 using supervised imitation learning to recover the same actions as the trained fully-constrained controller 404 for masked goals (i.e., constraints) in simulation, which is essentially a form of motion inpainting. As discussed in greater detail below in conjunction with FIG. 5, the reinforcement learning performed by the reinforcement learning module 404 can include, for each of a number of iterations, computing a reward based on a difference between a state of a character after performing an action output by the fully-constrained controller 404 and a ground-truth state of the character in the reference motions 154, and updating parameters of the fully-constrained controller 404 based on the reward. In some embodiments, the reward can also include one or more terms that do not depend on reference motions, such as energy consumption, impact minimization, and/or minimal motor jitter terms. The character can be a virtual character in a computer-based environment or a physical robot in a real-world environment, and the current state of the character can be received from the computer-based environment or sensed using sensors in the real-world environment. As discussed in greater detail below in conjunction with FIG. 6, the supervised imitation learning performed by the supervised imitation learning module 406 can include repeatedly sampling a motion from the reference motions 154 and a timestep within the motion, sampling a mask for a goal associated with the sampled motion, causing an action that is computed by the partially-constrained controller 151 for achieving the masked goal to be performed in a simulation, computing a ground-truth action using the fully-constrained controller 404, computing a similarity loss based on a comparison between the action and the ground-truth action, and updating parameters of the partially-constrained controller 151 based on the similarity loss.

More formally, in some embodiments, the first stage of the two-stage training can follow the framework of goal-conditioned reinforcement learning (GCRL) to train a versatile motion controller, namely the fully-constrained controller 404, that can be directed to perform a large variety of tasks. During the first stage, a reinforcement learning (RL) agent interacts with an environment (e.g., environment 170) according to a policy π. At each step t, the agent observes a state sₜ and a future goal gₜ. The agent then samples an action aₜ from the policy aₜ˜π(aₜ|sₜ,gₜ). After applying the action, the environment transitions to a new state sₜ₊₁ according to the environment dynamics p(sₜ₊₁|sₜ, aₜ), and the agent receives a reward rₜ=r(sₜ, aₜ, sₜ₊₁, gₜ). The objective of the agent is to learn a policy that maximizes the discounted cumulative reward:

$$J = {𝔼}_{p ( τ \vert π )} [ {\sum }_{t = 0}^{T} {γ}^{t} {r}_{t} ] , \qquad ( 1 )$$

where

$$p ( τ \vert π ) = p ( {s}_{0} ) {\prod }_{t = 0}^{T - 1} p ( {s}_{t + 1} \vert {s}_{t} , {a}_{t} ) π ( {a}_{t} \vert {s}_{t} , {g}_{t} )$$

is the likelihood of a trajectory τ=(s₀, a₀, r₀, . . . , s_{T-1}, a_{T-1},r_{T-1}, s_{T}). The discount factor γ∈[0,1) determines the effective horizon of the policy.

The second stage of the two-stage training leverages behavioral cloning (BC) to distill the teacher policy π*(i.e, the fully constrained controller 406), trained through RL, into a more versatile student policy π (e.g., the partially-constrained controller 151), which can be directed through multimodal inputs. In some embodiments, the policy distillation process is performed using the DAgger technique. In the online-distillation process, trajectories are collected by executing the student policy and then relabeled with actions from the teacher policy:

$${arg max}_{π} {𝔼}_{( s , g ) ∼ p ( s , g \vert π )} {𝔼}_{a ∼ {π}^{*} ( a \vert s , g )} [ log π ( a \vert s , g ) ] . \qquad ( 2 )$$

In equation (2), p(s,g|π) denotes the distribution of states and goals observed under the student policy.

FIG. 5 is a more detailed illustration of the reinforcement learning module 402 of FIG. 4, according to various embodiments. As shown, the reinforcement learning module 402 includes a score module 520. In operation, the reinforcement learning module 402 receives the reference motions 154 and samples a full goal 504 that includes a reference motion from the reference motions 154. During each iteration of training using the full goal 504, the reinforcement learning module 402 inputs, into the fully-constrained controller 404, a current state of the character and the target poses from a number of next frames in the full goal 504. Given such inputs, the fully-constrained controller 404 outputs an action 508. The reinforcement learning module 402 simulates the character performing the action and receives an updated state of the character from the environment 170. In some embodiments, the reinforcement learning module 402 transmits the action 508 to a controller of the character, such as a proportional derivative (PD) controller, that controls joints of the character to move within the environment 170 according to the action 508. Although described herein primarily with respect to a controller for illustrative purposes, in some embodiments, actions can be transmitted directly to a character as, e, direct torque forces for joints of the character.

The simulation of the character performing the action 508 results in an updated state 510 of the character, which the score module 520 uses to compute a reward 522 for updating parameters of the fully-constrained controller 404. In some embodiments, the score module 520 computes a reward based on a comparison of the updated state 510 with the state in a corresponding frame of the full goal 504 (and potentially other term(s) that do not depend on reference motions). Then, the reinforcement learning module 402 updates parameters of the fully-constrained controller 404 based on the computed reward 522. In some embodiments, the reinforcement learning module 402 can update parameters of the fully-constrained controller 404 using the reward and a backpropagation technique. Further, the foregoing steps can be repeated for multiple training iterations, until all frames of the full goal 504 have been used in the training. Then, the reinforcement learning module 402 can sample other full goals and perform training using those full goals.

More formally, the goal of physics-based motion tracking is to generate controls (such as motor actuations), which enable a simulated character to produce a motion {qₜ} that closely resembles a kinematic target motion {\hat{q}ₜ}. Motion can be represented as a sequence of poses qₜ, where each pose qₜ=(pₜ, θₜ) is encoded with a redundant representation consisting of the the 3D cartesian positions of a character's J joints

$${p}_{t} = ( {p}_{t}^{0} , {p}_{t}^{1} , … , {p}_{t}^{J} )$$

and their rotations

$${θ}_{t} = ( {θ}_{t}^{0} , {θ}_{t}^{1} , … , {θ}_{t}^{J} ) .$$

To successfully track a reference motion, controllers (e.g., fully-constrained controller 404) are typically provided with information that describes the motion it should imitate. Target poses are referred to herein as fully-constrained goals

$${g}_{t}^{full} ,$$

since the future poses provide complete information about the target motion the character should imitate.

The fully-constrained controller 404 is a fully-constrained motion tracking controller that is trained on the reference motions 154, which can be a large motion capture dataset in some embodiments. In some embodiments, the inputs to the fully-constrained controller 404 include the full-body target trajectories of a desired motion. The fully-constrained controller 404 can be trained to imitate a wide variety of motions, including those involving irregular terrains and object interactions. When the motion dataset only includes kinematic motion clips, the primary purpose of the fully-constrained controller 404, denoted herein by π^{FC}, can be to estimate the actions (motor actuations) required to control the simulated character. π^{FC} then provides the foundations that greatly simplifies the training process of a more versatile controller in the subsequent stage.

In some embodiments, the fully-constrained controller 404 is trained end-to-end to imitate target motions by conditioning on the full-body motion sequence and observations of the surrounding environment, such as the terrain and object heightmaps. The terrain can include any representation, such as a point cloud of heights or mesh, of a region around the character. The training objective can be formulated as a motion-tracking reward and optimized using reinforcement learning. At each step, π^{FC} observes the current humanoid state sₜ, including the 3D body pose and velocity, canonicalized with respect to the character's local coordinate frame:

$${s}_{t} = ( {θ}_{t} ⊖ {θ}_{t}^{root} , ( {p}_{t} - {p}_{t}^{root} ) ⊖ {θ}_{t}^{root} , {v}_{t} ⊖ {θ}_{t}^{root} ) , \qquad ( 3 )$$

where ⊖ denotes the quaternion difference between two rotations. In addition to the current state of the character, the policy also observes the next K target poses from the reference motion

$${g}_{t}^{F C} = [ {\hat{f}}_{t + 1} , … , {\hat{f}}_{t + K} ] .$$

The features for each joint

$${\hat{f}}_{t}^{j}$$

are canonicalized both relative to the current root, and relative to the current respective joint:

$${\hat{f}}^{j} = ( {\hat{θ}}^{j} ⊖ {θ}_{t}^{j} , {\hat{θ}}^{j} ⊖ {θ}_{t}^{root} , ( {\hat{p}}^{j} - {p}_{t}^{j} ) ⊖ {θ}_{t}^{root} , ( {\hat{p}}^{j} - {p}_{t}^{root} ) ⊖ {θ}_{t}^{root} ) . \qquad ( 4 )$$

The features for each target pose \hat{q}ₜ₊ₖ are also augmented with the time τₜ₊ₖ from the current timestep to the target pose, resulting in the following representation:

$$\{ {\hat{f}}_{t + k} = {\hat{f}}_{t + k}^{1} , … , {\hat{f}}_{t + k}^{J} , {τ}_{t + k} \} .$$

To imitate motions on irregular terrain, the character pose can be canonicalized with respect to the height of the terrain under the character's root (e.g., pelvis). During training, the fully-constrained controller 404 can be provided with a heightmap of the surrounding environment, with the heightmap oriented along the facing direction of the root. The heightmap has a fixed resolution, and records the height of the nearby terrain geometry and object surfaces.

Motion tracking is a sequence modeling problem. The objective is to predict the next actions based on the current character state, surrounding terrain, and a sequence of future target poses. In some embodiments, each of the inputs and design π^{FC} is tokenized by a transformer-based controller. This choice of architecture allows the fully-constrained controller 404 to attend to relevant information across the input sequence and capture the dependencies between the various input tokens. To further enhance the learning process, a critic network (not shown) can be employed alongside the transformer-based controller. The critic network can be implemented as a fully connected network that estimates the value function. Doing so provides a learning signal to guide the controller towards optimal actions.

In some embodiments, the reward 522, denoted herein by rₜ, encourages the character to track a reference motion by minimizing the difference between the state of the simulated character and the target motion:

$${r}_{t} = {w}^{gp} {r}_{t}^{gp} + {w}^{gr} {r}_{t}^{gr} + {w}^{rh} {r}_{t}^{rh} + {w}^{jv} {r}_{t}^{jv} + {w}^{jav} {r}_{t}^{jav} + {w}^{e g} {r}_{t}^{e g} , \qquad ( 5 )$$

where

$${r}_{t}^{\{ \cdot \}}$$

denote various reward components and and w^{{⋅}} are their respective weights. The terms in the reward function encourages the character to imitate the reference motion's global joint positions (gp), global joint rotations (gr), root height (rh), joint velocities (jv), joint angular velocities (jav), as well as an energy penalty (eg) to encourage smoother and less jittery motions. In some embodiments, the reward can also include one or more terms that do not depend on reference motions (e.g., energy consumption, impact minimization, and/or minimal motorjitter terms).

In some embodiments, early termination can be performed during training of the fully-constrained controller 404 in order to improve the success rate on rare and more complex motions. For example, in some embodiments, motions performed on flat terrain, can be terminated once any joint position deviates by more than a given amount, such as 0.25 meters. On irregular terrains, an episode is terminated when a joint error exceeds a given amount, such as 0.5 meters, providing the controller more flexibility to adapt the original reference motion to a new environment. In some embodiments, the model trainer 116 can also prioritize training on motions with a higher failure rate. As some motions are not expected to succeed in all scenarios (e.g., front-flip or cartwheel up a flight of stairs), the prioritized sampling only considers failures that occurred on flat terrain. The probability of prioritizing a motion mi is proportional to the probability of failing on that motion, clipped to a minimal weight of, e.g., 3e−3. Such adaptive sampling strategy can help ensure that the agent collects a sufficient amount of data to reproduce more dynamic and challenging behaviors.

FIG. 6 is a more detailed illustration of the supervised imitation learning module 406 of FIG. 4, according to various embodiments. As shown, the supervised imitation learning module 406 includes a sampling module, a masking module 608, and a score module 620. In operation, the supervised imitation learning module 406 receives the reference motions 154, and the sampling module 602 samples a full goal 606 that includes a sampled reference motion at a sampled time from the reference motions 154. During each iteration of training using the full goal 606, the masking module 608 generates a masked goal 610 that includes a random masking of a goal for a number of next frames in the full goal 504. In some embodiments, the goal can be specified in one or more modalities, which can include any suitable type(s) of data associated with motion of a character. For example, in some embodiments, the modalities can include the positions and/or orientations of any number of joints of a character in any number of the next frames, including a fully-observed motion in which no masking is applied; a text description of task(s) to be performed by the character in the next frames; and/or an object (e.g., specified as a bounding box surrounding the object, a point cloud, etc.) that the character is to interact with in the next frames. In such cases, training data for the different modalities can be obtained in any technically feasible manner. For example, in some embodiments, joint positions, rotations, and their relative timings can be extracted from motion capture data and, to improve generalization to new and unseen motions, the motions can be mirrored (e.g., flip left-to-right) as a form of data augmentation. As another example, motion sequences can be broken down into atomic behaviors, each of which can be labeled with text descriptions that provide text commands for a sparse goal, and the text descriptions can also be mirrored (e . . . , “a person turns left” can be converted to “a person turns right”). As yet another example, objects can be randomly sampled within classes of objects associated with motion clips of interacting with different categories of objects.

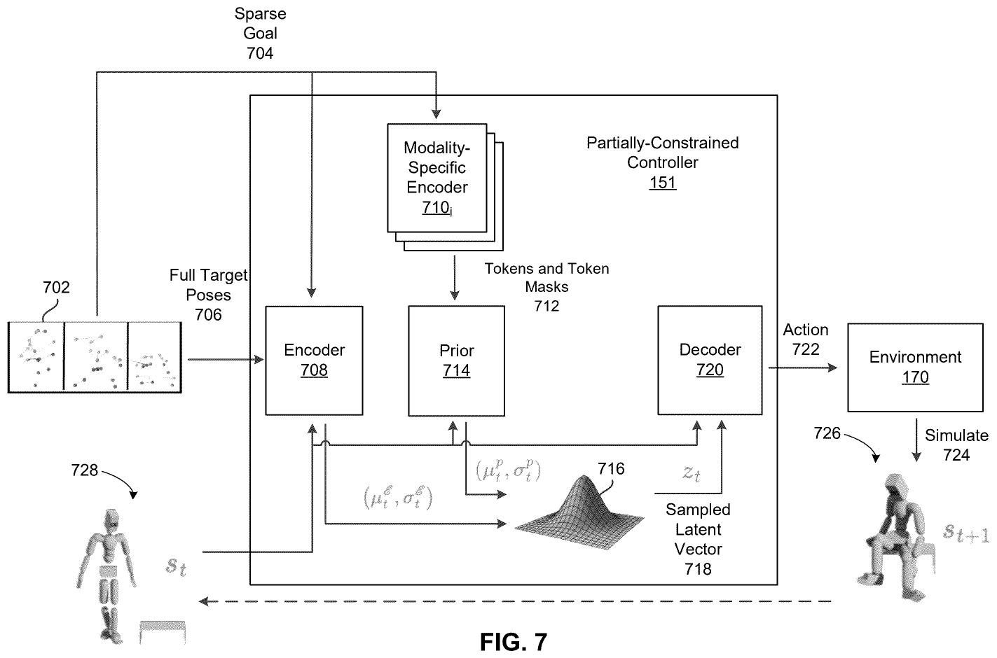

The masking module 608 samples a random mask for the goal in the next frames, which can include randomly sampling a mask for only a last frame when a sliding window is used and masks for all frames except the last frame were sampled in previous iterations. For example, in some embodiments, the random mask can mask out zero or more of the positions and/or orientations of the joints, the text description, and/or the object in zero or more of the next frames, resulting in the masked goal 610. In some embodiments, sampling of the random mask can include structured masking, described in greater detail below in conjunction with FIG. 7, and the structured masking can include sampling “time bubbles” during which no constraints other than certain types of constraints, such as a text or object constraint, are used. The time bubbles can help the partially-constrained controller 151 see sufficient examples of such constraints that remain largely fixed through time but can change with a certain probability, which can be similar to user-specified constraints, during training. For example, in some embodiments, whether a time bubble begins and the length of the time bubble can be sampled at each iteration of the sliding window, described above. In such cases, the supervised imitation learning module 406 can sample a mask for a current iteration based on the mask in a previous iteration and whether there are high-level constraints such as text descriptions or objects that may require a time bubble.

The supervised imitation learning module 406 inputs, into the partially-constrained controller 151, a current state of the character, the full goal 606, and the masked goal 610. Given such inputs, the partially-constrained controller 151 outputs an action 612. The supervised imitation learning module 406 simulates the character performing the action and receives an updated state of the character from the environment 170. In some embodiments, the supervised imitation learning module 406 transmits the action 612 to a controller of the character, such as a PD controller, that controls joints of the character to move within the environment 170 according to the action 612. The simulation of the character performing the action 612 results in an updated state 614 of the character.

The supervised imitation learning module 406 also inputs, into the fully-constrained controller 404, the current state of the character and the full goal 606 for the number of next frames corresponding to the masked goal 610. Given such inputs, the fully-constrained controller 404 outputs a ground truth action 620. The score module 620 computes a similarity loss 622 based on a comparison of the action 612 output by the partially-constrained controller 151 with the ground-truth action 616 output by the fully-constrained controller 404. Then, the supervised imitation learning module 406 updates parameters of the partially-constrained controller 151 based on the similarity loss 622. In some embodiments, the supervised imitation learning module 406 can update parameters of the partially-constrained controller 151 using the similarity loss 622 and a backpropagation technique, and the foregoing steps can be repeated for multiple iterations, until all frames of the full goal 606 have been used in the training. Then, the sampling module 602 of the supervised imitation learning module 406 can sample other full goals and perform training using those full goals. In some embodiments in which the partially-constrained controller 151 is a variational autoencoder (VAE), Kullback-Leibler (KL)-scheduling can be performed during training that uses a KL-divergent loss between an encoder and a prior, beginning with a low KL-coefficient and increasing the KL-coefficient over time, as discussed in greater detail below.

Partially observable goals (e.g., sparse goals) are also denoted herein as

$${g}_{t}^{partial} .$$

Such partial goals specify only some elements of a desired motion. To train a versatile partially-constrained controller 151 that can be directed using partial goals, the model trainer 116 trains the partially-constrained controller 151 on randomly masked observations of target motions. These masked observations are constructed using a random masking function

$$ℳ : {g}_{t}^{partial} = ℳ ( {g}_{t}^{full} ) .$$

The partially constrained controller 151 can also be directed via diverse control inputs. The versatility of the partially-constrained controller 151 arises from the masked training scheme. During training, the partially-constrained controller 151 is tasked with reconstructing a target full-body motion given the randomly masked inputs. Doing so enables the partially-constrained controller 151 to generate full-body motion from arbitrary partial constraints.

More specifically, in some embodiments, once the fully-constrained controller 404 has been trained, the fully-constrained controller 404 is then used to train the partially-constrained controller 151, denoted herein by π^{PC}. Given partial constraints, such as target positions for joints, text commands, or object locations, the partially-constrained controller 151, π^{PC}, generates diverse full-body motions that satisfy those constraints. π^{PC} is trained to model the distribution of actions

$${π}^{F C} ( {a}_{t} \vert {g}_{t}^{full} , {s}_{t} )$$

predicted by the fully-constrained controller π^{FC}, while only observing partial constraints gₜ^{partial} The partial constraints then provide users a versatile and convenient interface for directing π^{PC} to perform new tasks, without requiring task-specific training.

The objective of π^{PC} is to produce motions that conform to constraints specified by partial goals, akin to the task of motion inpainting. As described, some example goals include: (1) Any-joint-any-time: The model should support conditioning on target positions and rotations for any joint in arbitrary future timesteps; (2) Text-to-motion: The model should support high-level text commands, enabling more intuitive and expressive direction of the character's movements; and (3) Objects: When available, the model should support object-based goals, such as interacting with furniture. To produce a desired behavior, the partially-constrained controller 151 can support simultaneous conditioning on one or more of the aforementioned goals. For example, path following with raised arms can be achieved by conditioning the controller on a target root trajectory and a text command “walking while raising your hands”. This flexibility allows for a wide range of complex and expressive motions to be generated from concise partial specifications.

To train π^{PC}, flexible goals are extracted procedurally from the reference motions (e.g., motion capture data) by applying random masking. In some embodiments, the random masking can include the structured masking, described herein. During training, π^{PC} is trained to imitate the original full (unmasked) target motion by predicting the actions of the fully-constrained controller, which observes the ground-truth full target motion. Partial goals are an underspecified problem, as there may be multiple plausible motions that can satisfy a given set of partial goals. For example, when conditioned on reaching a target location within 1 second, there are a large variety of motions that can achieve this goal. To address such ambiguity, the partially-constrained controller 151, π^{PC}, can be modeled as a conditional variational autoencoder (C-VAE) in some embodiments. In such cases, the C-VAE model enables the π^{PC} to model the distribution of different behaviors that satisfy a particular set of constraints, rather than simply producing a single deterministic behavior. By sampling from a learned distribution, the C-VAE model can generate a variety of realistic and physically-plausible motions that adhere to the specified partial goals, while still allowing for natural variations and adaptability to different contexts.

In some embodiments, various training strategies can be used to improve the stability and effectiveness of the partially-constrained controller 151. In such cases, the strategies can include structured masking, KL-scheduling, episodic latent noise, and/or observation history. Furthermore, during the distillation process, deterministic actions can be sampled from both π^{FC} and π^{PC} to reduce stochasticity during data collection. Early termination can also be applied during distillation to prevent π^{PC} from entering states that were not observed during the training of π^{FC}. Since π^{FC} also trains with early termination, π^{FC} may not provide appropriate actions in regions π^{FC} has not experienced during training.

In some embodiments in which structured masking is used, the masking performed by the masking module 608 randomly removes individual target joints, the textual description, and the scene information. Such structured masking can result in increased robustness to possible user inputs. More specifically, the structured masking can include randomly removing individual target joints, the textual description, and the scene information (when applicable) from the input goals to the model. To better ensure temporally coherent behaviors, a masking scheme that is structured through time can be used. In such cases, a randomly sampled mask in one timestep has a chance of being repeated for multiple subsequent timesteps, as opposed to randomly re-sampling the mask at each step. Randomly re-sampling the mask on each step can reduce the ambiguity the model encounters during training. Therefore, the resulting model generalizes worse. This is because different joints are likely to be visible across different frames, the cross-frame information provides a less ambiguous description of the requested motion. By using a temporally consistent sampling scheme, joints can be observed for multiple consecutive frames, while other joints remain consistently hidden. To ensure the model supports high-level goals, such as text commands and interaction with a target object, all future poses can be masked out. This structured sampling mechanism helps guarantee that 7′C encounters, and learns to handle, a range of different masking patterns during training. Doing so results in increased robustness to possible user inputs.

In some embodiments in which KL-scheduling is used, a KL-coefficient can be initialized with a low value, such as 0.0001, and linearly increased to a higher value, such as 0.01, over the course of training. Starting with a low KL coefficient enables the partially-constrained controller 151 to more closely imitate π^{FC}. Increasing the coefficient then encourages the model to impose more structure into the learned latent space, to be more amenable to sampling from the prior at runtime.

In some embodiments in which episodic latent noise is used, during training, latents can be sampled via the reparametrization trick. To further encourage more temporally consistent behaviors, the “noise” parameter ∈˜N(0,1) can be kept fixed throughout the entire episode of training. Therefore, in each episode τ the latent variables are sampled according to

$${z}_{t}^{τ} = {ϵ}^{τ} {σ}_{t}^{τ} + {μ}_{t}^{τ} ,$$

and the noise ∈^{τ} is constant throughout an episode.

In some embodiments in which observation histories are used, when conditioning on text commands, the partially-constrained controller 151, π^{PC} can be provided with past poses, which experience has shown helps generate long coherent motions that conform to the intent of a given text command. In such cases, the prior of the partially-constrained controller 151 can be provided with a number (e.g, 5) of observations subsampled from the observations in the past timesteps (e.g., 40 past timesteps).

FIG. 7 is a more detailed illustration of the partially-constrained controller 151 of FIG. 4, according to various embodiments. As shown, the partially-constrained controller 151 is a VAE that includes an encoder 708, modality-specific encoders 7101 (referred to herein collectively as modality-specific encoders 710 and individually as a modality-specific encoder 710), a prior 714, and a decoder 720. Although described herein primarily with respect to VAEs as a reference example, in some embodiments, the partially-constrained controllers 151 and 152 can have any technically feasible architecture. For example, in some embodiments, the partially-constrained controllers 151 and 152 can be another type of generative model, such as a diffusion model, a feedforward model, or the like. The modality-specific encoders 710 are neural networks that are trained to tokenize (encode) different input modalities, such as joint constraints, text descriptions, and/or objects, in a sparse goal 704 that is derived from a reference motion 702 (which can be sampled from the reference motions 154) into tokens. In some embodiments, the modality-specific encoders 710 can also encode other inputs into the partially-constrained controller 151, such as the current character state, the surrounding terrain, and past poses. In some embodiments, the output of the modality-specific encoders 710 can be a sequence of tokens, each representing a different input into the model, and the tokens can also have the same token dimensions. In some embodiments, the tokens can include tokens for different character poses. Token masks are used to prevent the prior 714 from attending to unspecified inputs, such as joint constraints, text descriptions, and/or objects that are specified in the sparse objectives 704. In some embodiments, the token masks inform a transformer attention mechanism which tokens to ignore. The prior 714 is a neural network that takes as input the tokens and token masks 712 and outputs a base distribution. In some embodiments, the prior 714 can be a transformer-based neural network. The encoder 708, which is only used during training, is a neural network that takes as input the full target poses 706 and sparse goal 704 and outputs a residual to the base distribution output by the prior 714. In some embodiments, the encoder 708 can be a fully-connected neural network. Use of the encoder 708 during training can prevent outputs of the prior 714 from collapsing to the mean after training. The partially-constrained controller 151 adds the residual to the latent distribution to generate a prior distribution 716, which the partially-constrained controller 151 samples to obtain a sampled latent vector 718. The sampled latent vector 718 essentially represents a solution that should be applied. The partially-constrained controller 151 inputs the sampled latent vector 718 and a current state 728 of the character into the decoder 720, which outputs an action 722. In some embodiments, the decoder 720 can be a fully-connected neural network.

The model trainer 116 controls a character within the environment 170 using the action 722. As described, in some embodiments, the model trainer 116 can transmit the action 722 to a controller of the character, such as a PD controller, that controls joints of the character to move within the environment 170 according to the action 722. Then, the model trainer 116 receives an updated state 726 of the character from the environment 170, and the foregoing process can be repeated to generate another action for controlling the character at a subsequent time step, and so forth.

More formally, in some embodiments, the partially-constrained controller 151 includes the learnable prior 714, denoted herein by p; the encoder 708, denoted herein by ε; and the decoder 720, denoted herein by [symbol] . The encoder

$$ℰ ( {z}_{t} \vert {s}_{t} , {g}_{t}^{full} )$$

outputs a latent distribution given the fully-observable future target poses from the desired reference motion. The decoder [symbol] (aₜ|sₜ,zₜ) is then conditioned on a latent sampled from the encoder distribution, and produces an action for the simulated character. The final component is the learned prior

$$ρ ( {z}_{t} \vert {s}_{t} , {g}_{t}^{partial} ) .$$

The prior is trained to match the encoder distribution given only partially observed constraints. The learnable prior allows the partially-constrained controller 151 to generate natural motions from simple user-defined partial constraints at runtime, without requiring users to specify full target trajectories for the character to follow. The encoder is used solely for training, and is not utilized at runtime.

In some embodiments, the prior 714 can be modeled as a Gaussian distribution over latents zₜ, with mean μ^{ρ} and diagonal standard deviation matrix σ^{ρ},

$$ρ ( {z}_{t} \vert {s}_{t} , {g}_{t}^{partial} ) = 𝒩 ( {μ}^{ρ} ( {s}_{t} , {g}_{t}^{partial} ) , {σ}^{ρ} ( {s}_{t} , {g}_{t}^{partial} ) ) . \qquad ( 6 )$$

In some embodiments, the encoder 708 can be modeled as a residual to the prior,

$$ℰ ( {z}_{t} \vert {s}_{t} , {g}_{t}^{full} ) = 𝒩 ( {μ}^{ρ} ( {s}_{t} , {g}_{t}^{partial} ) + {μ}^{ℰ} ( {s}_{t} , {g}_{t}^{full} ) , {σ}^{ℰ} ( {s}_{t} , {g}_{t}^{full} ) ) . \qquad ( 7 )$$

Such a design helps ensure that the embedding from the encoder 708, having access to full observations of the target motion, stays close to the prior that only receives partial observations. During training, the latent variables zₜ are sampled from the encoder 708. All components can be trained using an objective (i.e., similarity loss) that maximizes the log-likelihood of actions predicted by π^{FC} and minimizes the KL divergence between the encoder 708 and the prior 714:

$${𝔼}_{( s , {g}^{partial} ) ∼ p ( s , {g}^{partial} \vert {π}^{P C} )} {𝔼}_{a ∼ {π}^{F C} ( a \vert s , {g}^{full} )} {𝔼}_{z ∼ ℰ ( z \vert s , {g}^{full} )} [ log 𝒟 ( a \vert s , z ) - α {D}_{K L} ( ℰ ( \cdot \vert s , {g}^{full} ) \vert \vert ρ ( \cdot \vert s , {g}^{partial} ) ) ] , \qquad ( 8 )$$

where g^{partial} is constructed by applying a random masking function [symbol] to the original fully-observed goals: g^{partial}= [symbol] (g^{full}) In the formulation above, π^{PC} interacts with the environment, while π^{FC} labels the target actions for every timestep. Other similarity losses, such as an L2 loss, can be used in some embodiments. More generally, in some embodiments, the second stage of training can include a combination of matching a ground truth action and/or maximizing a reward via reinforcement learning. During inference, the encoder 708 is discarded, and latents are sampled only from the prior 714.

In some embodiments, to provide a unified architecture capable of processing multi-modal inputs, the prior R can be modeled using a transformer-encoder. Doing so enables variable length input tokens depending on the observable goals at each timestep. For example, each input modality (target pose \hat{q}_{t+τ}, object bounding box oₜ, terrain heightmap hₜ, current pose sₜ, text wₜ, and historical pose q_{t-τ}) can have a unique encoder that is shared across all inputs of the same modality. When an input is masked out, the transformer masking mechanism can be used to exclude the respective tokens. In some embodiments, the output of the transformer is provided to two fully-connected layers to output the mean and log-standard deviation for the prior distribution. Since the encoder 708 always observes the full target frames as input, one natural structure for the encoder 708 is a fully connected model, as inputs to the encoder 708 are always a fixed size. More generally, any technically feasible encoder 708, such as a transformer or other structure, can be used in some embodiments. The encoder observes the full future poses \hat{q}_{t+τ} in addition to the masking applied to the keyframes, indicating which joints are visible to the prior. In addition, the encoder 708 observes the current pose sₜ and the terrain heightmap hₜ. Like the prior, two fully-connected output heads can be used to output the residual mean and the logstd for the encoder. Similarly, the decoder 720 can also be modeled as a fully-connected network. The decoder 720 observes the current state sₜ, the sampled latent zₜ, and the terrain heightmap hₜ. The decoder 720 then outputs a deterministic action aₜ.

In some embodiments, the input modalities that π^{PC} can receive as input can be represented as follows. The objective is to provide a sufficiently rich representation, that is also computationally efficient and facilitates generalization to new tasks. To represent keyframes, a future keyframe with partially observable joints can first be canonicalized to the current pose (equation (3)). The unobserved joints can then be zeroed out, and the mask is appended alongside the time to reach the target frame τ[\hat{q}_{t+τ}*mask_{t+τ}, mask_{tτ}, τ]. Observations of poses from previous timesteps can be represented in a similar fashion, but all the joints are observed and no masking is applied. In some embodiments, each object can be represented using the positions of the 8 corners of a bounding box, canonicalized to the character's local coordinate frame; as a point cloud; or in any other technically feasible manner. To identify different types of objects, an index representing the object type (e.g., chair, sofa, stool) can be used. To represent text, each text command can be encoded using embeddings, which can be trained on video-language pairs to better capture temporal relationships. By leveraging the spatio-temporal information in videos during training, the embeddings can encode the temporal aspects of language crucial for describing motions, making the embeddings well-suited for representing text commands to be translated into character animations.

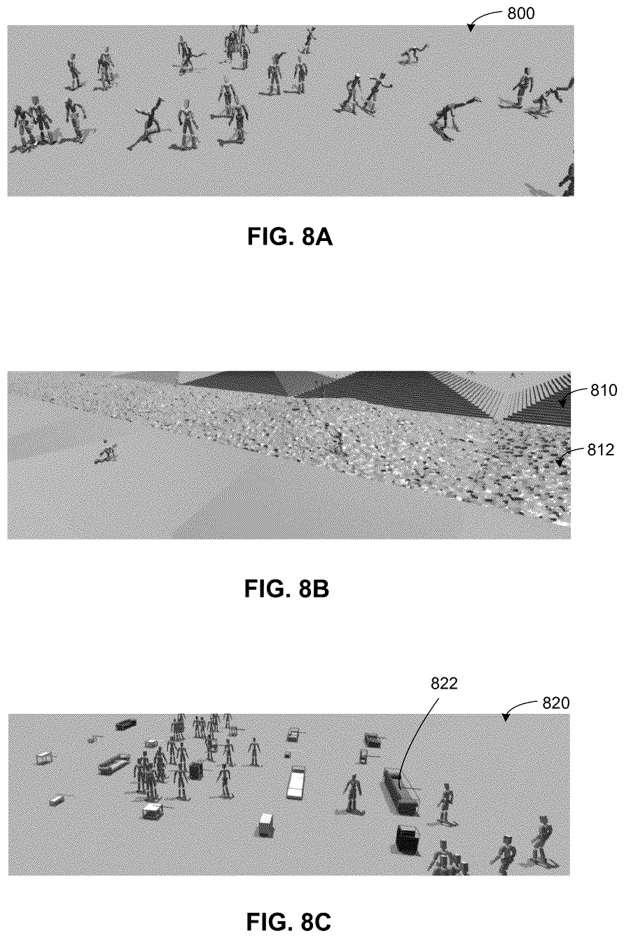

FIGS. 8A-8C illustrate exemplar simulated terrains that can be used during training of the fully-constrained controller 404 and the partially-constrained controller 151, according to various embodiments. As described above in conjunction with FIG. 4, in some embodiments, different simulated terrains can be used during training so that the trained partially-constrained controller 151 can be used to control a character to perform tasks on different terrains. In such cases, the character can be spawned in random terrains during different episodes of training, and the positions of reference motions and masked goals in different frames can be canonicalized with respect to the terrain that is used. For example, in some embodiments, the random terrains can be random locations on a terrain that includes different regions. FIG. 8A illustrates a region 800 that includes flat terrain. The flat terrain can enable controllers, such as the fully-constrained controller 404 and the partially-constrained controller 151, to produce an original reference motion in a setting that best represents how the reference motion was recorded. The flat terrain is a simple environment where the controllers can focus primarily on imitating the reference motions, assuming most of the training data was recorded on flat ground. The flat terrain can be a baseline for evaluating a controller's ability to imitate motions in a simple, unobstructed setting.

FIG. 8B illustrates a second region 812 with rough terrain, and a third region 810 with stairs and slopes. The rough terrain, stairs, and slopes allow controllers to learn robust motion skills on varied ground geometries. More generally, in some embodiments, irregular terrain regions can include a wide variety of irregular terrain features, such as stairs, rough gravellike terrain, and slopes (both smooth and rough). When an agent is imitating a motion that does not involve object interactions, the agent can be spawned at any random location within flat and irregular terrain regions. Such a setup exposes a controller to diverse terrain conditions, allowing the controller to learn robust locomotion skills that can accommodate different types of terrains.

FIG. 8C illustrates a fourth region 820 that is used for interactions with objects, such as object 822. The fourth region 820 permits controllers to practice interacting with objects in a clean and reproducible setup, without interference from irregular terrain features. In some embodiments, the object interaction region can include various objects placed on flat ground, such as chairs, tables, and couches. In such cases, characters can be only initialized in such a region when the characters are imitating motions that involve object interactions.

FIG. 9 is a more detailed illustration of the control application 146 of FIG. 1, according to various embodiments. As shown, the control application 146 includes the partially-constrained controller 152. In operation, the control application 146 receives sparse goal 902. The sparse goal 902 can specify task(s) for a character to perform using any number of modalities that the partially-constrainer controller 152 is trained to process. For example, in some embodiments, the sparse goal can include positions and/or orientations of any number of joints of a character in any number of frames of an animation, including a fully-observed motion in which no masking is applied; a text description of task(s) to be performed by the character; and/or an object (e.g., specified as a bounding box of the object, a point cloud, etc.) that the character is to interact with. The sparse goal 902 can be specified by a user in any technically feasible manner, such as via a graphical user interface (GUI), in some embodiments. The control application 146 inputs the sparse goal 902 and a current state of the character into the partially-constrained controller 152 to generate an action 904. Then, the control application 146 controls a character within the environment 170 using the generated action 904. Although described herein primarily with respect to the partially constrained controller 152 controlling a character within the same environment 170 for illustrative purposes, in some embodiments, the control application 146 can use the partially-constrained controller 152 to control a character within a different environment than the environment used during training. For example, in some embodiments, the control application 146 can transmit the action 904 to a controller of the character, such as a PD controller, that controls joints of the character to move within the environment 170 (or another environment) according to the action 904. The control application 146 receives an updated state 906 of the character from the environment 170 (or another environment), which can be used along with the sparse goal 902 to generate further actions for controlling the character.

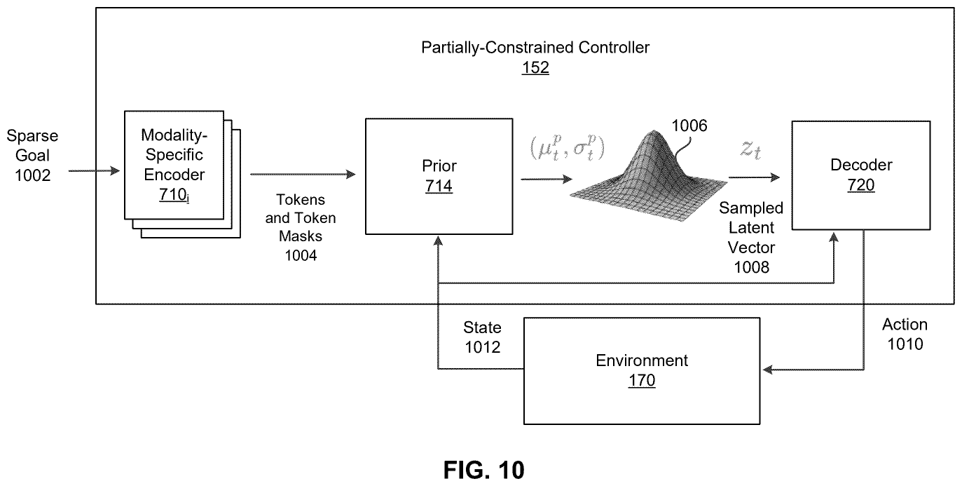

FIG. 10 is a more detailed illustration of how the partially-constrained controller 152 of FIG. 1 is used to control a character, according to various embodiments. As shown, given as input a sparse goal 1002, which can be similar to the sparse goal 902 described above in conjunction with FIG. 9, the control application 146 encodes the sparse goal 1002 using the modality-specific encoders 710 to generate tokens, and the control application 146 concatenates the tokens with token masks to generate tokens and token masks 1004. In some embodiments, the control application 146 inputs the different modalities of input in the sparse goal 1002 into corresponding modality-specific encoders, which output the tokens. In some embodiments, the modality-specific encoders 710 can also encode other inputs into the partially-constrained controller 152, such as the current character state, the surrounding terrain, and past poses. In addition, the transformer attention mechanism can be used to mask out tokens that are not in use via the token masks. As described, the token masks prevent the transformer from attending to unspecified inputs, such as a keyframe without any target joints, or a sequence without text or object conditioning.

The control application 146 inputs the tokens and token masks 1004 and a current state 1012 of a character into the prior 714, which outputs a prior distribution 1006. Then, the control application 146 samples the prior distribution 1006 to obtain a latent vector 1008. Thereafter, the control application 146 inputs the sampled latent vector 1008 and a current state of the character into the decoder 720, which outputs an action 1010. The control application 146 controls a character within the environment 170 using the action 1010. As described, in some embodiments, the control application 146 can transmit the action 1010 to a controller of the character, such as a PD controller, that controls joints of the character to move within the environment 170 according to the action. Then, the control application 146 receives an updated state of the character from the environment 170, and the foregoing process can be repeated to generate another action for controlling the character at a subsequent time step, and so forth. It should be noted that the partially-constrained controller 152 does not include the encoder 708 of the partially-constrained controller 151, because the encoder 708 can be discarded after training of the partially-constrained controller 151.

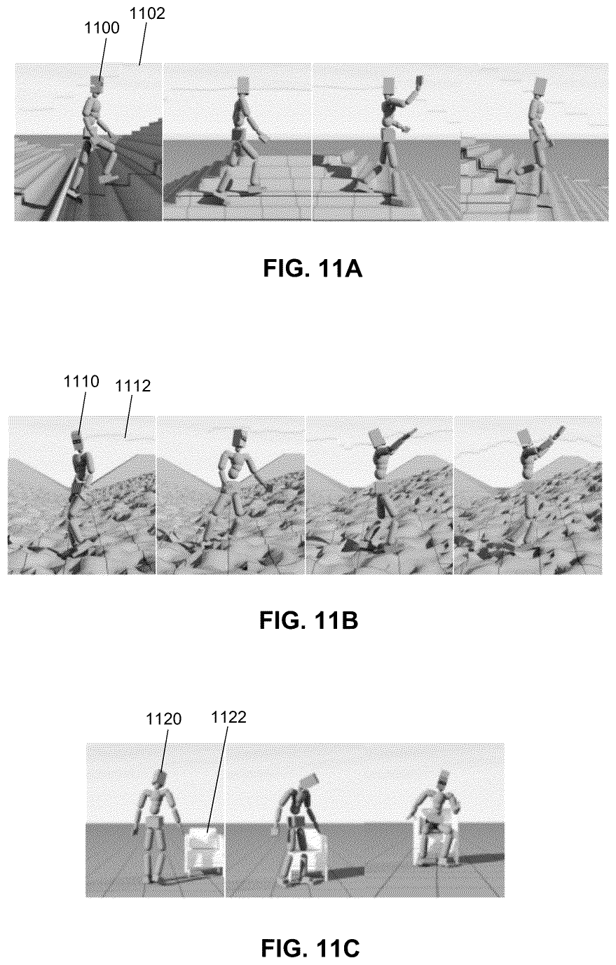

FIGS. 11A-11C illustrates exemplar motions generated by controlling a character using different modalities, according to various embodiments. As shown in FIG. 11A, when a sparse goal is specified as a path 1102 for a character 1100 to follow, the partially-constrained controller 152 can be used to generate motions for the character 1100 to follow the path 1112 over terrain that includes stairs and slopes. In this example, the path 1102 includes coordinates for a head of the character 1100 to follow. As shown in FIG. 11B, when a sparse goal is specified as a path 1112 for a character 1110 to follow plus the text “a person raises both hands and walks forward,” the partially-constrained controller 152 can be used to generate motions for the character 1110 to raise both hands while walking forward along the path 1112 over rough terrain. As shown in FIG. 11C, when a sparse goal is specified as the bounding box of an object, shown as an armchair 1122, the partially-constrained controller 152 can be used to generate motions for a character 1120 to approach and interact with the armchair 1122, such as sitting on the armchair 1122.

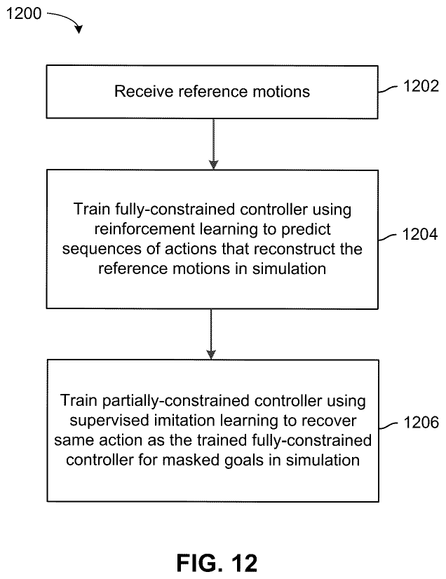

FIG. 12 sets forth a flow diagram of method steps for training a fully-constrained controller and using the trained fully-constrained controller to train a partially-constrained controller, according to various embodiments. Although the method steps are described in conjunction with FIGS. 1-7 and 9-10, persons skilled in the art will understand that any system configured to perform the method steps, in any order, falls within the scope of the present invention.

As shown, a method 1200 begins at step 1202, where model trainer 116 receives reference motions 154 for use in training the fully-constrained controller 404 and the partially-constrained controller 151. As described, in some embodiments, the reference motions 154 can be a motion capture dataset that includes captured motions of humans performing various motions. In such cases, the reference motions 154 can include the positions and rotations for each joint in each frame of the captured motions.

At step 1204, the model trainer 116 trains the fully-constrained controller 404 using reinforcement learning to predict sequences of actions that reconstruct the reference motions in simulation. The reinforcement learning can include, for each of a number of iterations, computing a reward based on a difference between a state of the character after performing an action output by the fully-constrained controller 404 and a ground-truth state of the character in the reference motions, and updating parameters of the fully-constrained controller 404 based on the reward. In some embodiments, the reward can also include one or more terms that do not depend on reference motions (e.g., energy consumption, impact minimization, and/or minimal motorjitter terms).

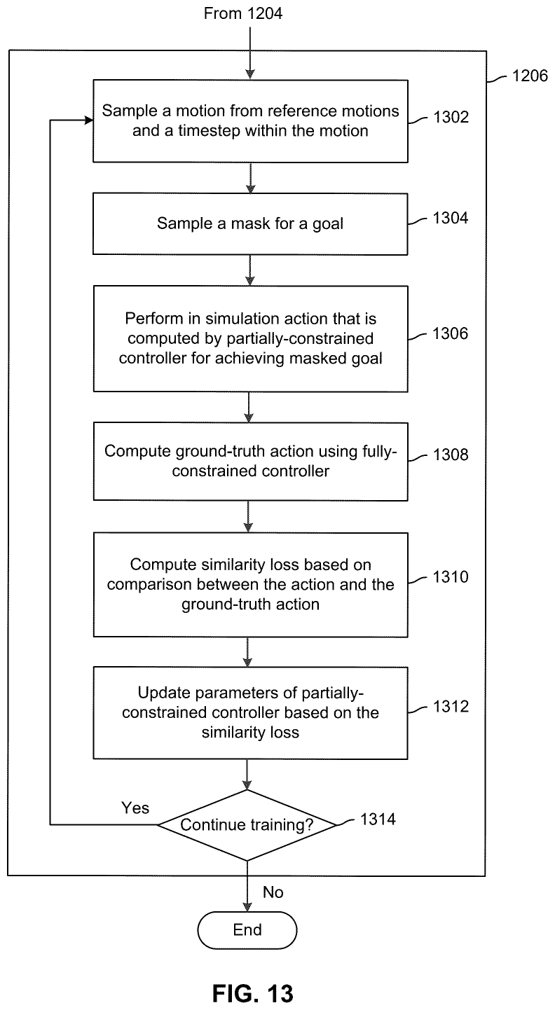

At step 1206, the model trainer 116 trains the partially-constrained controller 151 using supervised imitation learning to recover the same actions as the trained fully-constrained controller 404 for masked goals in simulation. In some embodiments, the model trainer 116 can train the partially-constrained controller 151 by repeatedly sampling a motion from the reference motions 154 and a timestep within the motion, sampling a mask for a goal associated with the sampled motion, causing an action that is computed by the partially-constrained controller 151 for achieving the masked goal to be performed in a simulation, computing a ground-truth action using the fully-constrained controller 404, computing a similarity loss based on a comparison between the action and the ground-truth action, and updating parameters of the partially-constrained controller 151 based on the similarity loss, as discussed in greater detail below in conjunction with FIG. 13.

FIG. 13 sets forth a flow diagram of method steps for training a partially-constrained controller at step 1206 of the method 1200, according to various embodiments. Although the method steps are described in conjunction with FIGS. 1-7 and 9-10, persons skilled in the art will understand that any system configured to perform the method steps, in any order, falls within the scope of the present invention.

As shown, at step 1302, the model trainer 116 samples a motion from the reference motions 154 and a timestep within the motion.

At step 1304, the model trainer 116 samples a mask for a goal associated with the sampled motion and timestep. The goal can include positions and/or orientations of any number of joints of a character in any number of frames of an animation, a text description of task(s) to be performed by the character; and/or an object that the character is to interact with. The mask randomly masks out portions of the goal from one or more frames. In some embodiments, sampling of the mask can include sampling time bubbles during which no constraints other than certain types of constraints, such as a text or object constraint, are used. For example, in some embodiments, whether a time bubble begins and the length of the time bubble can be sampled at each iteration of a sliding window during training, as described above in conjunction with FIG. 6.

At step 1306, the model trainer 116 causes an action that is computed by the partially-constrained controller 151 for achieving the masked goal to be performed in a simulation. In some embodiments, the partially-constrained controller 151 can input the masked goal and a current state of the character into the partially-constrained controller 151, which outputs an action for the character that can be simulated within the environment 170.

At step 1308, the model trainer 116 computes a ground-truth action using the fully-constrained controller 404. In some embodiments, the model trainer 116 inputs the full goal and the current state of the character into the fully-constrained controller 404, which outputs the ground-truth action.

At step 1310, the model trainer 116 computes a similarity loss based on a comparison between the action and the ground-truth action. In some embodiments, the similarity loss can be an objective that maximizes the log-likelihood of actions predicted by the fully-constrained controller 106 and minimizes the KL divergence between the encoder 708 and the prior 714 of the partially-constrained controller 151, as described above in conjunction with FIG. 7. More generally, any technically feasible loss can be used in some embodiments. For example, when the distributions are delta functions, a mean-squared-error loss can be used in some embodiments. As another example, for more general functions, KL divergence can be used in some embodiments. In some embodiments, a combined reward for tracking the original motion and additional regularization terms, in addition to a binary cross-entropy loss with respect to the ground truth action, can be used.

At step 1312, the model trainer 116 updates parameters of the partially-constrained controller 151 based on the similarity loss (and optionally the reward, described above). In some embodiments, the model trainer 116 can update the parameters of the encoder 708, the prior 714, and the decoder 720 in the partially-constrained controller 151 using the similarity loss and a backpropagation technique. In some embodiments in which the partially-constrained controller 151 is a VAE, KL-scheduling can be performed during training, beginning with a low KL-coefficient and increasing the KL-coefficient over time, as described above in conjunction with FIGS. 6-7.

At step 1314, if the model trainer 116 determines to continue training, then the method 1200 returns to step 1302, where the model trainer 116 samples another motion from the reference motions and a timestep within the motion. For example, training can terminate after a specific number of training iterations or if the similarity loss does not improve significantly over a number of training iterations.

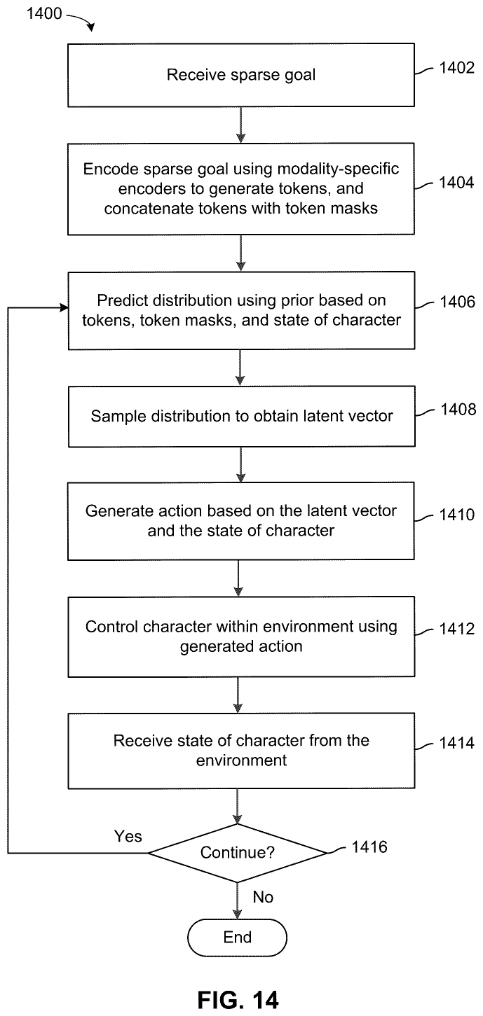

FIG. 14 sets forth a flow diagram of method steps for generating an animation of a character given a sparse goal, according to various embodiments. Although the method steps are described in conjunction with FIGS. 1-7 and 9-10, persons skilled in the art will understand that any system configured to perform the method steps, in any order, falls within the scope of the present invention.

As shown, a method 1400 begins at step 1402, where the control application 146 receives a sparse goal. The sparse goal can be specified by a user in any technically feasible manner, such as via a GUI. As described, the sparse goal can specify task(s) for a character to perform using any number of modalities that the partially-constrainer controller 152 is trained to process. For example, in some embodiments, the sparse goal can include positions and/or orientations of any number of joints of a character in any number of frames of an animation, including a fully-observed motion in which no masking is applied; a text description of task(s) to be performed by the character; and/or an object that the character is to interact with. In some embodiments in which the sparse goal includes an object, the object can be specified in any technically feasible manner, such as using a point cloud or bounding box that is computed from an image of the object or specified by the user.

At step 1404, the control application 146 encodes the sparse goal using modality-specific encoders 710 to generate tokens, and concatenates the tokens with token masks. In some embodiments, the control application 146 inputs the different modalities of input in the sparse goal into corresponding modality-specific encoders 710, which output the tokens. In such cases, the transformer attention mechanism can be used to mask out tokens that are not in use via the token masks, preventing the transformer from attending to unspecified inputs, as described above in conjunction with FIG. 10. In some embodiments, the modality-specific encoders 710 can also encode other inputs into the partially-constrained controller 152, such as the current character state, the surrounding terrain, and past poses.

At step 1406, the control application 146 predicts a distribution using the prior 714 of the partially-constrained controller 152 based on the tokens, the token mask, and a state of the character. In some embodiments, the control application 146 inputs the tokens, the token mask, and the state of the character into the prior 714, which outputs the distribution.

At step 1408, the control application 146 samples the distribution to obtain a latent vector. In some embodiments, the control application 146 can sample the distribution by sampling random noise and then using the reparameterization trick to obtain the latent vector.

At step 1410, the control application 146 generates an action based on the latent vector and the state of the character. In some embodiments, the control application 146 inputs the latent vector and a current state of the character into the decoder 720, which outputs the action.

At step 1412, the control application 146 controls the character within the environment 170 using the generated action. In some embodiments, the control application 146 transmits the action to a controller of the character, such as a PD controller, or directly to the character, in order to control joints of the character to move within the environment 170 according to the action.

At step 1414, the control application 146 receives a state of the character from the environment 170. The state can include updated joint positions and orientations of the character after performing the action.

At step 1416, if the control application 146 determines to continue controlling the character, then the method 1400 returns to step 1406, where the control application 146 again predicts a distribution using the prior 714 based on tokens, token mask, and the state of character.

In sum, techniques are disclosed for animating characters using sparse goals. In some embodiments, a sparse goal can be specified in various modalities, such as joint constraints, a text description, and/or an object that a character interacts with. A control application processes the goal input in each modality using a corresponding modality-specific encoder to generate tokens. Given the tokens, token masks indicating which tokens are associated with unspecified inputs, and a current state of the character, the control application samples a prior latent distribution generated by a prior of a trained partially-constrained controller to obtain a sampled latent vector. The character can be a virtual character in a computer-based environment or a physical robot in a real-world environment, and the current state of the character can be received from the computer-based environment or sensed using sensors in the real-world environment. The control application inputs the sampled latent vector and the current state of the character into a decoder of the partially-constrained controller to generate an action. Thereafter, the control application can control the character within the computer-based environment or the real-world environment using the action. Control of the character can result in an updated state of the character, and the foregoing process can be repeated to generate another action for controlling the character using the updated state of the character, the sparse goal, and the partially-constrained controller.

A model trainer can perform a two-stage training technique to train the partially-constrained controller. In the two-stage technique, the model trainer (1) trains a fully-constrained controller using reinforcement learning to predict sequences of actions that reconstruct reference motions in simulation, and then (2) trains the partially-constrained controller using supervised imitation learning to recover the same actions as the trained fully-constrained controller for masked goals in simulation. The reinforcement learning can include, for each of a number of iterations, computing a reward based on a difference between a state of a character after performing an action output by the fully-constrained controller and a ground-truth state of the character in the reference motions, and updating parameters of the fully-constrained controller based on the reward. In some embodiments, the reward can also include one or more regularization terms on the motion, such as regularization term(s) for reducing energy consumption, impact minimization, and/or minimal motorjitter terms. The supervised imitation learning can include repeatedly sampling a motion from the reference motions and a timestep within the motion, sampling a mask for a goal associated with the sampled motion, simulating an action that is computed by the partially-constrained controller for achieving the masked goal, computing a ground-truth action using the fully-constrained controller, computing a similarity loss (e.g., an L2 or KL divergence loss) based on a comparison between the action and the ground-truth action, and updating parameters of the partially-constrained controller based on the similarity loss. More generally, the second stage of training can include a combination of matching a ground truth action and/or maximizing a reward.

At least one technical advantage of the disclosed techniques relative to the prior art is that, with the disclosed techniques, a physical or virtual character can be animated to perform different motions without specifying all of the joints of the character in any number of frames of an animation. Animations generated using the disclosed techniques are also more physically plausible relative to what can be achieved by animations generated using kinematic models that do not consider the forces that cause the joints of a character to move. In addition, the disclosed techniques permit animators to effectively control animations by specifying joint constraints, text descriptions, and/or objects that characters interact with. These technical advantages represent one or more technological improvements over prior art approaches.

1. In some embodiments, a computer-implemented method for training machine learning models to animate characters comprises performing, using a set of motion recordings, one or more first operations to train a first untrained machine learning model to generate a first trained machine learning model that is configured to animate a character based on motion data as input, and performing, using the set of motion recordings and the first trained machine learning model, one or more second operations to train a second untrained machine learning model to generate a second trained machine learning model that is configured to animate the character based on user input.

2. The computer-implemented method of clause 1, wherein the one or more first operations comprise one or more reinforcement learning operations, and the one or more second operations comprise one or more supervised learning operations.

3. The computer-implemented method of clauses 1 or 2, wherein the one or more first operations train the first untrained machine learning model to process one or more motions included in the set of motion recordings to generate one or more actions for controlling the character in order to reproduce the one or more motions.

4. The computer-implemented method of any of clauses 1-3, wherein the one or more second operations train the second untrained machine learning model to process user inputs in multiple modalities to generate actions for controlling the character.

5. The computer-implemented method of any of clauses 1-4, wherein the one or more second operations train the second untrained machine learning model using a comparison between actions for controlling the character generated by the second untrained machine learning model and actions for controlling the character generated by the first trained machine learning model.

6. The computer-implemented method of any of clauses 1-5, wherein the one or more second operations comprise sampling a goal associated with a first motion included in the set of motion recordings, generating, via the first trained machine learning model and using the first motion, a first action for controlling the character, generating, via the second untrained machine learning model and using a masked goal derived from the goal, a second action for controlling the character, and updating one or more parameters of the second untrained machine model based on a comparison between the first action and the second action.

7. The computer-implemented method of any of clauses 1-6, wherein the masked goal is generated based on a masked goal used during a previous training iteration.

8. The computer-implemented method of any of clauses 1-7, wherein the one or more second operations comprise increasing a value of a Kullback-Leibler (KL)-coefficient while performing successive training iterations when training the second untrained machine learning model.

9. The computer-implemented method of any of clauses 1-8, wherein the second trained machine learning model comprises at least one of a trained variational autoencoder (VAE) or a trained generative model.

10. The computer-implemented method of any of clauses 1-9, further comprising receiving one or more goals specified in one or more modalities, generating, via the second trained machine learning model and using the one or more goals, a first action for the character to perform, and causing the character to perform the first action within a computer-based or physical environment.

11. In some embodiments, one or more non-transitory computer-readable media store instructions that, when executed by at least one processor, cause the at least one processor to perform the steps of performing, using a set of motion recordings, one or more first operations to train a first untrained machine learning model to generate a first trained machine learning model that is configured to animate a character based on motion data as input, and performing, using the set of motion recordings and the first trained machine learning model, one or more second operations to train a second untrained machine learning model to generate a second trained machine learning model that is configured to animate the character based on user input.

12. The one or more non-transitory computer-readable media of clause 11, wherein the one or more first operations comprise one or more reinforcement learning operations, and the one or more second operations comprise one or more supervised learning operations.

13. The one or more non-transitory computer-readable media of clauses 11 or 12, wherein the one or more second operations further comprise one or more reinforcement learning operations.

14. The one or more non-transitory computer-readable media of any of clauses 11-13, wherein the one or more first operations are based on at least one reward that reduces energy consumption, minimizes impact, or minimizes motorjitter.

15. The one or more non-transitory computer-readable media of any of clauses 11-14, wherein the one or more first operations train the first untrained machine learning model to process one or more motions included in the set of motion recordings to generate one or more actions for controlling the character in order to reproduce the one or more motions.

16. The one or more non-transitory computer-readable media of any of clauses 11-15, wherein the one or more second operations train the second untrained machine learning model to generate an action for controlling the character based on an input specifying at least one of a set of constraints associated with a subset of joints belonging to the character for one or more frames, a textual description of a task for the character to perform, or an object for the character to interact with.

17. The one or more non-transitory computer-readable media of any of clauses 11-16, wherein the one or more second operations train the second untrained machine learning model using a comparison between actions for controlling the character generated by the second untrained machine learning model and actions for controlling the character generated by the first trained machine learning model.

18. The one or more non-transitory computer-readable media of any of clauses 11-17, wherein the one or more second operations comprise sampling a goal associated with a first motion included in the set of motion recordings, generating, via the first trained machine learning model and using the first motion, a first action for controlling the character, generating, via the second untrained machine learning model and using a masked goal derived from the goal, a second action for controlling the character, and updating one or more parameters of the second untrained machine model based on a comparison between the first action and the second action.

19. The one or more non-transitory computer-readable media of any of clauses 11-18, wherein the second trained machine learning model comprises one or more encoders associated with one or more input modalities, a prior, and a decoder.

20. In some embodiments, a system comprises one or more memories storing instructions, and one or more processors that are coupled to the one or more memories and, when executing the instructions, are configured to perform, using a set of motion recordings, one or more first operations to train a first untrained machine learning model to generate a first trained machine learning model that is configured to animate a character based on motion data as input, and perform, using the set of motion recordings and the first trained machine learning model, one or more second operations to train a second untrained machine learning model to generate a second trained machine learning model that is configured to animate the character based on user input.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for training machine learning models to animate characters, the method comprising:
performing, using a set of motion recordings, one or more first operations to train a first untrained machine learning model to generate a first trained machine learning model that is configured to animate a character based on motion data as input; and
performing, using the set of motion recordings and the first trained machine learning model, one or more second operations to train a second untrained machine learning model to generate a second trained machine learning model that is configured to animate the character based on user input.

2. The computer-implemented method of claim 1, wherein the one or more first operations comprise one or more reinforcement learning operations, and the one or more second operations comprise one or more supervised learning operations.

3. The computer-implemented method of claim 1, wherein the one or more first operations train the first untrained machine learning model to process one or more motions included in the set of motion recordings to generate one or more actions for controlling the character in order to reproduce the one or more motions.

4. The computer-implemented method of claim 1, wherein the one or more second operations train the second untrained machine learning model to process user inputs in multiple modalities to generate actions for controlling the character.

5. The computer-implemented method of claim 1, wherein the one or more second operations train the second untrained machine learning model using a comparison between actions for controlling the character generated by the second untrained machine learning model and actions for controlling the character generated by the first trained machine learning model.

6. The computer-implemented method of claim 1, wherein the one or more second operations comprise:
sampling a goal associated with a first motion included in the set of motion recordings;
generating, via the first trained machine learning model and using the first motion, a first action for controlling the character;
generating, via the second untrained machine learning model and using a masked goal derived from the goal, a second action for controlling the character; and
updating one or more parameters of the second untrained machine model based on a comparison between the first action and the second action.

7. The computer-implemented method of claim 6, wherein the masked goal is generated based on a masked goal used during a previous training iteration.

8. The computer-implemented method of claim 1, wherein the one or more second operations comprise increasing a value of a Kullback-Leibler (KL)-coefficient while performing successive training iterations when training the second untrained machine learning model.

9. The computer-implemented method of claim 1, wherein the second trained machine learning model comprises at least one of a trained variational autoencoder (VAE) or a trained generative model.

10. The computer-implemented method of claim 1, further comprising:
receiving one or more goals specified in one or more modalities;
generating, via the second trained machine learning model and using the one or more goals, a first action for the character to perform; and
causing the character to perform the first action within a computer-based or physical environment.

11. One or more non-transitory computer-readable media storing instructions that, when executed by at least one processor, cause the at least one processor to perform the steps of:
performing, using a set of motion recordings, one or more first operations to train a first untrained machine learning model to generate a first trained machine learning model that is configured to animate a character based on motion data as input; and
performing, using the set of motion recordings and the first trained machine learning model, one or more second operations to train a second untrained machine learning model to generate a second trained machine learning model that is configured to animate the character based on user input.

12. The one or more non-transitory computer-readable media of claim 11, wherein the one or more first operations comprise one or more reinforcement learning operations, and the one or more second operations comprise one or more supervised learning operations.

13. The one or more non-transitory computer-readable media of claim 12, wherein the one or more second operations further comprise one or more reinforcement learning operations.

14. The one or more non-transitory computer-readable media of claim 11, wherein the one or more first operations are based on at least one reward that reduces energy consumption, minimizes impact, or minimizes motorjitter.

15. The one or more non-transitory computer-readable media of claim 11, wherein the one or more first operations train the first untrained machine learning model to process one or more motions included in the set of motion recordings to generate one or more actions for controlling the character in order to reproduce the one or more motions.

16. The one or more non-transitory computer-readable media of claim 11, wherein the one or more second operations train the second untrained machine learning model to generate an action for controlling the character based on an input specifying at least one of a set of constraints associated with a subset of joints belonging to the character for one or more frames, a textual description of a task for the character to perform, or an object for the character to interact with.

17. The one or more non-transitory computer-readable media of claim 11, wherein the one or more second operations train the second untrained machine learning model using a comparison between actions for controlling the character generated by the second untrained machine learning model and actions for controlling the character generated by the first trained machine learning model.

18. The one or more non-transitory computer-readable media of claim 11, wherein the one or more second operations comprise:
sampling a goal associated with a first motion included in the set of motion recordings;
generating, via the first trained machine learning model and using the first motion, a first action for controlling the character;
generating, via the second untrained machine learning model and using a masked goal derived from the goal, a second action for controlling the character; and
updating one or more parameters of the second untrained machine model based on a comparison between the first action and the second action.

19. The one or more non-transitory computer-readable media of claim 11, wherein the second trained machine learning model comprises one or more encoders associated with one or more input modalities, a prior, and a decoder.

20. A system, comprising:
one or more memories storing instructions; and
one or more processors that are coupled to the one or more memories and, when executing the instructions, are configured to:
perform, using a set of motion recordings, one or more first operations to train a first untrained machine learning model to generate a first trained machine learning model that is configured to animate a character based on motion data as input, and
perform, using the set of motion recordings and the first trained machine learning model, one or more second operations to train a second untrained machine learning model to generate a second trained machine learning model that is configured to animate the character based on user input.
